(19) United States
(12) Patent Application Publication
(10) Pub. No.: US 2007/0100129 A1
(43) Pub. Date: May 3, 2007

(54) Low expansion polyimide, resin composition and article using thereof

(76) Inventor: Katsuya Sakayori, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/542,555

(22) Filed: Oct. 3, 2006

(30) Foreign Application Priority Data
May 10, 2005 (JP) 2005-292995

(51) Int. Cl. C08G 69/08

(52) U.S. Cl. 528/310

(57) ABSTRACT

A low expansion polyimide using an inexpensive aromatic dianhydride having good heat resistance. A polyimide resin composition useful as a resin material for forming a product or part requiring a low thermal expansion coefficient and heat resistance, by using the polyimide. A product or part which has a good heat resistance and is produced from the resin composition. The polyimide has a repeating unit represented by: 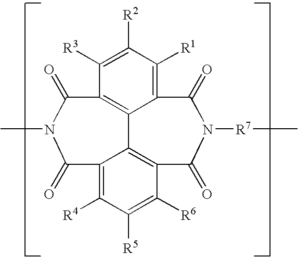
wherein R¹ to R⁶ is a hydrogen atom or monovalent organic group, and R¹ to R⁶ may be bonded to each other. R⁷ is a divalent organic group.

### BACKGROUND OF THE INVENTION

1. Field of the Invention

The present invention relates to a polymer compound having good dimensional stability. Suitably, it relates to a polyimide having good heat resistance. Particularly, it relates to the polyimide which can be suitably used as a material (e.g. an insulating material for electronics) to provide a product or part for which good dimensional stability is required as well as heat resistance. The present invention also relates to a resin composition containing such a polyimide, and relates to an article which is produced by using such a resin composition.

2. Description of the Related Art

Polymer material is used for various familiar products due to its properties such as high processability, lightness in weight or the like. Polyimide developed by DuPont, U.S., in 1955 has been further developed so as to apply to an aerospace field or the like because of its excellent heat resistance. Since then, in detailed studies done by many researchers, it was found that properties such as heat resistance, dimensional stability, insulating property and the like are good among organic matters showing top-class properties, hence, polyimide has been applied not only to the aerospace field but also to an insulating material of electronic parts and the like. Nowadays, polyimide is increasingly utilized as a chip coating film of a semiconductor element, a substrate of a flexible printed-wiring board and the like.

Polyimide is a polymer which is synthesized from diamine and acid dianhydride. Polyamide acid (polyamic acid) which is a precursor of polyimide is obtained by reacting diamine and acid dianhydride in liquid. Then, polyimide can be obtained through a dehydration and ring-closure reaction. Generally, since polyimide is poor in solubility to a solvent and difficult to process, polyimide is often obtained by making its precursor, which is polyamide acid, into a desired form followed by heating. Polyamide acid decomposes by heat or water, thus, it is not good in storage stability. Taking the point into consideration, there is developed a polyimide having a molecular structure into which a skeleton for providing a good solubility is introduced, so that the polyimide can be molded or coated in its solution state obtained by dissolving the obtained polyimide in a solvent. However, this polyimide tends to be inferior in chemical resistance or adhesiveness to a substrate to the polyimide obtained by the means using a precursor. Hence, either means using a precursor or means using solvent-soluble polyimide is used in accordance with the purpose.

Recently, polyimide is used extensively as an insulating material for electronics. Thereby, there is a demand for various performances of polyimide. Particularly, as for parts such as printed-wiring board in which polyimide is laminated with metals, or as for semiconductor products in which polyimide is laminated with inorganic materials, it is required that polyimide has a linear thermal expansion coefficient equal to that of metal or inorganic material, in order to improve flatness of substrate and/or adhesiveness to substrate.

As for polyimide using 2,2′,6,6′-biphenyltetracarboxylic dianhydride as an acid component, Goin et al., U.S., discloses in POLYMER LETTERS Vol. 6, p. 821-825 (1968) that after refining polyamide acid obtained by reacting 2,2′,6,6′-biphenyltetracarboxylic dianhydride with 4,4′-diamino diphenyl ether in dimethylacetamide by reprecipitation using diethyl ether, polyamide acid liquid obtained by being dissolved again in dimethylacetamide is cast followed by heating gradually up to 300° C., and thus obtained polyimide. The thermally decomposing temperature of polyimide is merely disclosed herein, and other physical properties are not stated in detail.

Also, JP-A No. Sho. 56-52722 similarly discloses to utilize polyimide synthesized by using 2,2′,6,6′-biphenyltetracarboxylic dianhydride and 4,4′-diamino diphenyl ether as a liquid crystal orientation film, however, an ability to orient a liquid crystal is merely disclosed herein, and other physical properties are not disclosed.

In Example of JP-A No. Hei. 6-41205, polyimide using 2,2′,6,6′-biphenyltetracarboxylic dianhydride is disclosed, however, the polyimide is used as a protective film which prevents polymers from adhering to a polymerization container. It is mentioned about a primary coloring of the polymer produced in the polymerization container having the protective film provided, however, physical properties of polyimide itself are not stated at all.

JP-A No. Hei. 6-329799 discloses a method for producing a molded body of polyimide and 2,2′,6,6′-biphenyltetracarboxylic dianhydride is mentioned as one representative example of a starting material, however, compound names are merely listed without actual synthesis examples, thus, no specific physical property can be learned.

JP-A No. Hei. 11-140181 discloses a method for producing polyimide microparticles and 2,2′,6,6′-biphenyltetracarboxylic dianhydride is mentioned herein as a representative example of a starting material, however, compound names are merely listed without actual synthesis examples, thus, no specific physical property can be learned.

JP-A No. 2002-60489 discloses polyimide and an adhesive tape obtained by using the same. 2,2′,6,6′-biphenyltetracarboxylic dianhydride is also mentioned herein as a representative example of a starting material, however, compound names are merely listed without actual synthesis examples, thus, no specific physical property can be learned.

JP-A No. Hei. 3-275725 discloses a method for producing a photoconductive polymer. 2,2′,6,6′-biphenyltetracarboxylic dianhydride is also mentioned herein as a representative example of a material, however, compound names are merely listed without actual synthesis example, thus, no specific physical property can be learned.

As described above, although polyimide produced by using 2,2′,6,6′-biphenyltetracarboxylic dianhydride has been known, the physical properties thereof has not been known in detail. Furthermore, there is few specific examples of copolymer of 2,2′,6,6′-biphenyltetracarboxylic dianhydride with any other dianhydride, and physical properties thereof has not been disclosed.

### SUMMARY OF THE INVENTION

Polyimide has been applied to semiconductor or electronics because of its heat resistance and high insulating ability. Therefore, it is often laminated with a single crystal silicon or metal such as copper. And, attempts are conventionally made in order to lower the linear thermal expansion coefficient of polyimide to a level of the single crystal silicon or metal.

It is understood that a factor greatly contributing to the linear thermal expansion coefficient of polyimide is its chemical structure. Generally, it is considered that the expansion coefficient reduces as polymer chain of polyimide becomes rigid and the linearity thereof becomes high. Therefore, many structures have been proposed for dianhydride and diamine, which are raw materials of polyimide, in order to lower the expansion coefficient of polyimide.

Dianhydride used for polyimide to exert the low expansion property is typically pyromellitic dianhydride, and 3,3′,4,4′-biphenyltetracarboxylic dianhydride. In addition to them, there are proposed 1,4,5,8-naphthalenetetracarboxylic dianhydride or terphenyltetracarboxylic dianhydride, as aromatic dianhydride. However, they do not have sufficient solubility, or are expensive because of complicated synthesis route. There are also proposed 1,2,3,4-cyclobutanetetracarboxylic dianhydride or 1,2,4,5-cyclohexanetracarboxylic dianhydride and the like as aliphatic diandydride. However, these aliphatic dianhydrides have thermal decomposing temperatures lower than those of aromatic dianhydrides. Therefore, there is a problem about their heat resistance.

On the other hand, as diamine, benzidine derivatives such as p-phenylenediamine, diamino diphenyl ether and 2,2′-dimethyl-4,4′-diaminobiphenyl are mainly used.

The present invention has been accomplished in view of the above problems. It is therefore an object of the present invention to obtain low-expansion polyimide by using an aromatic dianhydride which has a good heat resistance and is not expensive. It is also an object of the present invention to provide a resin composition which is useful as a resin material to constitute a product or part for which the low linear thermal expansion coefficient is strongly demanded as well as the heat resistance, by using such a polymer compound. Furthermore, the object includes providing a product or part having a good heat resistance which is produced from such a resin composition. Particularly, the object is to provide a product or part in which the polyimide or the resin composition of the present invention is applied to a use in which the polyimide or the resin composition has a boundary surface in contact with inorganic material such as metal, metal oxide, or single crystal silicon.

The polyimide of the present invention in order to solve the above problems is characterized in that it comprises a repeating unit represented by a following formula (1): 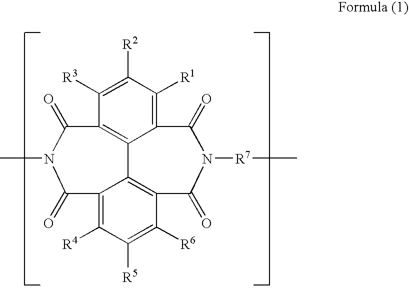
wherein R¹ to R⁶ is independently a hydrogen atom or monovalent organic group, and R¹ to R⁶ may be bonded to each other. R⁷ is a divalent organic group. Groups represented by the same symbol among the repeating units existing in the same molecule may be different atoms or structures.

The imide skeleton included in a repeating unit of the above formula (1) is an aromatic skeleton having good heat resistance. And, the skeleton is a rigid skeleton having high linearity, at least in a site originated from dianhydride.

Therefore, the polyimide of the present invention having the repeating unit of the formula (1) has not only the good heat resistance but also the low linear thermal expansion coefficient.

Next, a polyimide resin composition according to the present invention is characterized in that it contains the polyimide according to the present invention. This polyimide resin composition has not only the heat resistance and the insulation property but also a good dimensional stability against the temperature change during a heating process. Therefore, this composition can be used in any known field or product using a resin material, such as pattern forming material (resist), coating material, paint, printing ink, adhesive, filler, electronic material, molding material, resist material, architectural material, three dimensional modeling, film for flexible display, optical material and so on.

Particularly, the polyimide resin composition according to the present invention is suitable for a field or product in which these properties are effective. For example, it is suitable for forming paint, printing ink, color filter, flexible display film, semiconductor device, electronic device, interlayer insulation film, wiring coating film, optical circuit, optical circuit component, antireflection film, hologram, optical member or building material.

### BRIEF DESCRIPTION OF THE DRAWINGS

FIG. 1A is a view showing a stereo structure model of a compound having a skeleton of the formula (1), as seen from a direction vertical to the structural formula.

FIG. 1B is a view showing a stereo structure model of a compound having a skeleton of the formula (1), as seen from a direction horizontal to the structural formula.

### DETAILED DESCRIPTION OF THE PREFERRED EMBODIMENTS

The present invention will be explained in detail below. The inventor has been studied molecular design in accordance with a quite novel idea, and has accomplished the polyimide having good heat resistance and low linear thermal expansion coefficient, preferably the wholly aromatic polyimide. That is, the inventor found 7-membered ring imide structure and confirmed the effect thereof, as a novel option to achieve the low linear thermal expansion coefficient which had been achieved by the limited structure only.

Generally, it is considered that the heat resistance of the polymer can be improved by introducing a cross-linking structure. Because, even if a part of the linkage of the molecular chain is broken by thermal energy, the ladder-like structure restrains the breaking of the molecular chain as a whole, since there is another linkage parallel to the disconnected chain. As the ladder-like structure, an ideal structure is made of a plurality of benzene rings which are linked to one after another in such a manner that two adjacent rings share two carbon atoms of each ring. In addition to the ideal structure, the ladder-like structure includes unsaturated bonds such as double bond, triple bond, or aromatic structure such as benzene ring. Therefore, generally so-called high heat resistant polymer often has an aromatic structure.

Since it is considered that the thermal expansion is caused by the vibration of each atom due to the thermal energy, it is important to increase the bond energy of each bond constituting the polymer chain, and introduce the skeleton for restraining the vibration of atoms, in order to achieve the low linear thermal expansion coefficient. In view of the low expansion, the double bond or conjugate structure is effective. In view of restraining the vibration of atoms, the ladder-like structure is effective. In order to exert such an effect from a more macroscopic viewpoint, it is preferable that the number of the bending points of the polymer main chain is small. Consequently, if the molecular chain becomes rigid and linear, the low expansion property is appeared.

It is preferable that the polyimide has the ladder-like structure containing many aromatic structures, and has a conformation of which linearity is high, in order to make the polyimide have both the heat resistance and the low expansion.

In a polyimide having an aromatic 5-membered ring imide structure represented by a polyimide derived from pyromellitic dianhydride and a polyimide having an aromatic 6-membered ring imide structure represented by a polyimide derived from 1,4,5,8,-naphthalenetetracarboxylic dianhydride, since all atoms relating to the imide bond are arranged planarly and stably, a conjugated structure of Π electrons tends to spread over a molecular chain of the polyimide. Therefore, these polyimides have the good heat resistance and the low expansion property, although the precursor thereof may have a difficulty in its solubility.

Also, a polyimide derived from 3,3′,4,4′-biphenyltetracarboxylic dianhydride has two imide groups bonded to different benzene rings, and has a 5-membered structure imide group having a planar structure. Therefore, the benzene ring thereof and the imide group are Π-conjugated. Furthermore, in the structure, bonds from nitrogens of two imide groups existing at both sides of the biphenyl skeleton to components derived from diamines are not parallel. Therefore, the low expansion polyimide can be obtained only by introducing a rigid amine such as p-phenylenediamine. That is, the selection of diamine is limited to a narrow range.

The present inventors have studied and found that the polyimide derived from 2,2′,6,6′-biphenyltetracarboxylic dianhydride having a structure of the following formula (4) has a low linear expansion coefficient and has a high heat resistance.

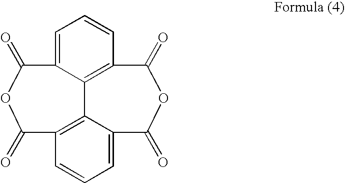

2,2′,6,6′-biphenyltetracarboxylic dianhydride is an acid dianhydride having two ring acid anhydride portions of 7-membered ring structure in which all carbons constituting this dianhydride belong to aromatic component. This dianhydride reacts with a diamine to form an amic acid. Then, the amic acid is imidized to form the polyimide having the ring imide portions of 7-membered ring structure represented by the following formula (5).

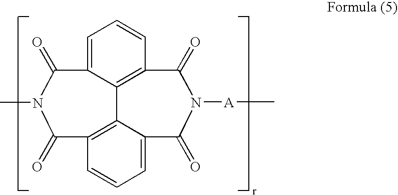

In the above formula, A means a divalent organic group, and r means a natural number equal to 1 or more.

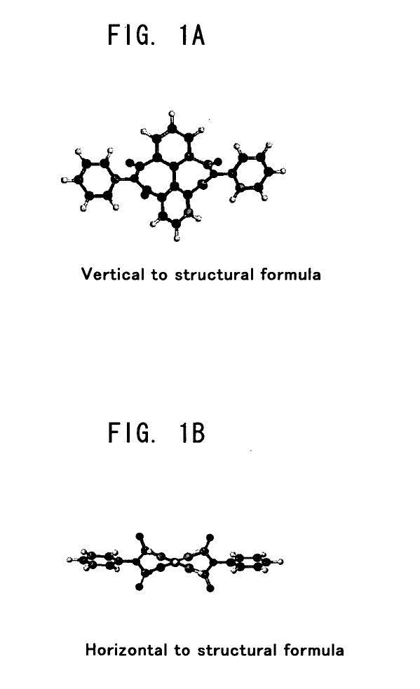

FIG. 1A shows a spatial configuration estimated from a result of a MM2 molecular mechanical calculation of a model compound having the 7-membered ring structure represented by the following formula, as seen from a direction vertical to the structural formula. FIG. 1B shows a spatial configuration estimated from a result of a MM2 molecular mechanical calculation of a model compound having the 7-membered ring structure represented by the following formula, as seen from a direction horizontal to the structure. In this model compound, two benzene rings and the imide bonds do not exist in the same plane, and two benzene rings have a configuration in which they have a lean of 30-40 degrees relative to each other.

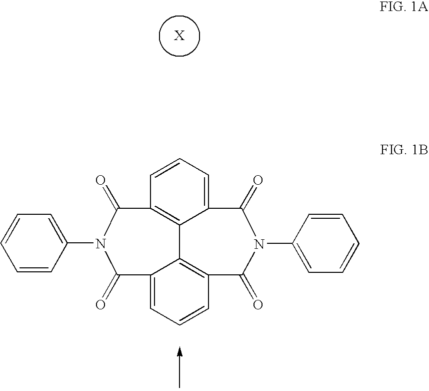

That is, in 2,2′,6,6′-biphenyltetracarboxylic dianhydride, the bond for bonding benzene rings of the biphenyl skeleton is rotatable. Therefore, two benzene rings of the dianhydride is twisted by forming the 7-membered ring imide structure via imidization.

Different from the conventional imide group derived from aromatic acid dianhydride such as pyromellitic dianhydride or 3,3′,4,4′-biphenyltetracarboxylic dianhydride, two carbonyl bonds constituting the imide group do not exist in the same plane and the imide group does not have a conjugated structure, in the 7-membered ring structure derived from 2,2′,6,6′-biphenyltetracarboxylic dianhydride.

The bonds extending from nitrogen atoms of two imide groups of the model compound to components derived from diamines are parallel to each other. In view of this, the skeleton derived from this acid dianhydride is similar to the structure derived from pyromellitic acid dianhydride, so that the low expansion polyimide can be formed.

Therefore, the polyimide having a repeating unit of 7-membered ring imide structure derived from 2,2′,6,6′-biphenyltetracarboxylic dianhydride has a highly heat resistant aromatic skeleton, and has a rigid and highly linear skeleton at least at a site derived from acid dianhydride.

It is therefore possible to obtain the low linear thermal expansion polyimide by suitably selecting diamine for reacting with 2,2′,6,6′-biphenyltetracarboxylic dianhydride (i.e. diamine constituting the portion represented by the symbol A in the above formula (5)).

It is furthermore possible to finely control the linear thermal expansion coefficient by combining the repeating unit of the imide structure derived from the acid dianhydride indicating the low linear thermal expansion coefficient, which is conventionally known, with the repeating unit of the 7-membered ring imide structure derived from 2,2′,6,6′-biphenyltetracarboxylic dianhydride (i.e. the repeating unit represented by the above formula (5)).

The low expansion polyimide of the present invention according to the above idea is characterized in that it has the repeating unit represented by the following formula (1) including the 7-membered ring imide structure.

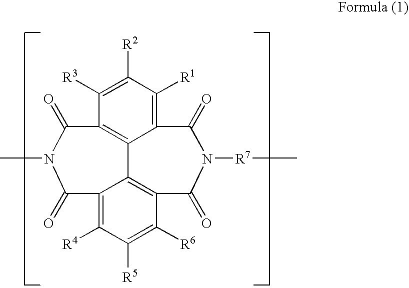

In the above formula, R¹ to R⁶ means independently a hydrogen atom or monovalent organic group, and may be bonded to each other. R⁷ means a divalent organic group. The groups represented by the same symbols among the repeating units existing in the same molecule may be different atoms or structures.

Here, the repeating unit constituting the polymer skeleton includes the repeating units of both main chain skeleton and side chain skeleton. Particularly, it is preferable to satisfy the above conditions when focused on the repeating unit constituting the main chain skeleton.

The polyimide according to the present invention has the imide skeleton included in the repeating unit of the formula (1), that is, the 7-membered ring imide structure derived from 2,2′,6,6′-biphenyltetracarboxylic dianhydride or the compound which is substituted at the aromatic ring thereof. Since the component derived from the acid dianhydride is rigid and has no bending point, and includes two aromatic rings, the low expansion and highly heat resistant polyimide can be obtained. Furthermore, since the polyimide itself is rigid, the diamine structure for obtaining the low expansion polyimide can be selected in a wider range.

Furthermore, 2,2′,6,6′-biphenyltetracarboxylic dianhydride which is a raw material of the above-mentioned 7-membered ring imide structure can be obtained at a low cost, because it uses 2,2′,6,6′-biphenyltetracarboxylic acid as a raw material which is obtained by a relatively simple synthesizing method such as an oxidation of pyrene.

Therefore, the polyimide according to the present invention can be applied suitably to any field in which the high dimensional stability is required as well as the properties inherent to the polyimide such as heat resistance.

In the repeating unit represented by the above-mentioned formula (1), a substituent other than hydrogen atom may be introduced to a position of R¹ to R⁶. Insofar as the repeating unit of the formula (1) has a 7-membered ring imide skeleton derived from 2,2′,6,6′-biphenyltetracarboxylic dianhydride, the polyimide according to the present invention has a good heat resistance and a good dimensional stability, and is expected to have the same effect even if a substituent is introduced to R¹ to R⁶.

A monovalent organic group other than hydrogen atom which can be introduced to a position of R¹ to R⁶ may be for example halogen atom, hydroxy group, mercapto group, primary amino group, secondary amino group, tertiary amino group, cyano group, silyl group, silanol group, alkoxy group, nitro group, carboxyl group, acetyl group, acetoxy group, sulfo group, saturated or unsaturated alkyl group, saturated or unsaturated halogenated alkyl group, aromatic group such as phenyl or naphthyl, an allyl group and so on. R¹ to R⁶ may be the same or different from each other. Two or more groups among R¹ to R⁶, particularly, two or three groups among R¹ to R³ and/or two or three groups among R⁴ to R⁶ may be bonded each other to form a ring structure.

As the substituent R¹ to R⁶, it is possible to use a dianhydride which already has the substituent R¹ to R⁶, as the raw material, or introduce them in a form of polyimide or polyamide acid obtained by the reaction with diamine. Also, it is possible to control a wavelength of light to be absorbed by introducing the substituent. And, it is possible to absorb a predetermined wavelength by introducing the substituent.

The polyimide of the present invention can also improve the solubility by introducing the substituent in the molecule structure. From this viewpoint, the above-mentioned R¹ to R6 may be preferably saturated or unsaturated alkyl group having 1 to 15 carbon atoms, saturated or unsaturated alkoxy group having 1 to 15 carbon atoms, bromo group, chloro group, fluoro group, nitro group, primary to tertiary amino groups and so on. These groups may exist at the above-mentioned divalent organic group R⁷.

R⁷ in the formula (1) is a divalent organic group. Specific examples include a divalent organic group corresponding to each diamine component, which will be discussed later, i.e. a structure obtained by removing both end amino groups relating to the formation of the polyimide chain from the diamine component. The groups represented by the same symbols among repeating units existing in the same polyimide chain may be different atoms or structures.

The polyimide according to the present invention is an aromatic polyimide in which at least a part derived from the acid dianhydride has an aromatic structure. From the viewpoint of improving the heat resistance and the dimensional stability of the polyimide, the polyimide according to the present invention is preferably a wholly aromatic polyimide in which a part derived from the diamine also has an aromatic structure.

Therefore, R⁷ which is a structure derived from the diamine component included in the formula (1), and Y which is a structure derived from the diamine component included in the formula (2) which will be discussed later are preferably structures derived from the aromatic diamine.

Here, the wholly aromatic polyimide is a polyimide obtained by copolymerizing the aromatic acid component and the aromatic amine component, or polymerizing the aromatic acid/amino component. The aromatic acid component is a compound having one or more aromatic rings, all or part of which is substituted by all 4 acid groups constituting the polyimide skeleton. The aromatic amine component is a compound having one or more aromatic rings, all or part of which is substituted by both 2 amino groups constituting the polyimide skeleton. The aromatic acid/amino component is a compound having one or more aromatic rings, all or part of which is substituted by both the acid groups and the amino groups constituting the polyimide skeleton. Here, as clearly seen from specific examples of the raw material which will be discussed later, all acid groups or amino groups do not necessarily bond to the same aromatic ring.

On the other hand, the amine component for constituting a structure of R⁷ of the formula (1) or Y part of the formula (2) may be one kind of diamine, or may be two or more kinds of diamine. The amine to be used may be, without limitation, p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3+-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 2,2-di(3-aminophenyl)-1,1,1,3,3,3-hexafluoropropane, 2,2-di(4-aminophenyl)-1,1,1,3,3,3-hexafluoropropane, 2-(3-aminophenyl)-2-(4-aminophenyl)-1,1,1,3,3,3-hexafluoro propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 1,3-bis(3-amino-α,α-ditrifluoromethylbenzyl)benzene, 1,3-bis(4-amino-α,α-ditrifluoromethylbenzyl)benzene, 1,4-bis(3-amino-α,α-ditrifluoromethylbenzyl)benzene, 1,4-bis(4-amino-α,α-ditrifluoromethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis [4-(3-aminophenoxy)phenyl]ketone, bis [4-(4-aminophenoxy)phenyl]ketone, bis [4-(3-aminophenoxy)phenyl]sulfide, bis[4-(4-aminophenoxy)phenyl] sulfide, bis [4-(3-aminophenoxy)phenyl]sulfone, bis [4-(4-aminophenoxy)phenyl]sulfone, bis [4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenylether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′,3′-tetramethyl-1,1′-spirobiindane, 6,6′-bis(4-aminophenoxy)-3,3,3′,3′-tetramethyl-1,1′-spirobiindane, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2,2,1]heptane, or 2,5-bis(aminomethyl)bicyclo[2,2,1]heptane. It is also possible to use a diamine in which all or part of hydrogen atoms bonded to the aromatic ring of the above-mentioned diamine are substituted by a substituent selected from fluoro group, methyl group, methoxy group, trifluoromethyl group or trifluoromethoxy group. Moreover, according to the purpose, it is possible to use a diamine in which one or more kinds of ethynyl group, benzocyclobutene-4′-yl group, vinyl group, allyl group, cyano group, isocyanate group and isopropenyl group, which will be one or more crosslinking points, may be introduced to all or part of the hydrogen atoms bonded to the aromatic ring of the above-mentioned diamine.

Diamine can be selected according to the desired physical property. If a rigid diamine such as p-phenylenediamine is used, the thermal expansion coefficient becomes low. As rigid diamine in which two amino groups bond together to the same aromatic ring, there may be p-phenylenediamine, m-phenylenediamine, 1,4-diaminonaphthalene, 1,5-diaminonaphthalene, 2,6-diaminonaphthalene, 2,7-diaminonaphthalene, 1,4-diaminoanthracene.

Further, there may be diamine in which two or more aromatic rings are bonded by single bonds and two or more amino groups are respectively bonded to a different aromatic ring directly or as a part of a substituent. For example, the following formula (6) may be exemplified. Specifically, there may be benzidine or the like:

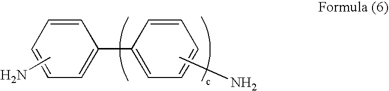

In the above formula, “c” is a natural number equal to 1 or more; and the amino groups are bonded at a meta or para position relative to the bond between the benzene rings.

Further, in the formula (6), it is possible to use a diamine having a substituent which does not relate to a bond to other benzene rings and is bonded to the benzene ring at a position other than a position where the amino group is bonded. These substituents, which are monovalent organic groups, may be bonded to each other.

Specifically, for example, there may be 2,2′-dimethyl-4,4′-diaminobiphenyl, 2,2′-ditrifluoromethyl-4,4′-diaminobiphenyl, 3,3′-dichloro-4,4′-diaminobiphenyl, 3,3′-dimethoxy-4,4′-diaminobiphenyl, 3,3′-dimethyl-4,4′-diaminobiphenyl or the like.

As the aromatic diamine as mentioned above, the diamine having the following structure is especially preferable. From the viewpoint of the high heat resistance and the low linear thermal expansion property, it is preferable to use only the diamine providing the divalent organic groups as represented by the following formulae. However, the diamine providing other structure may be used insofar as the properties of the polyimide is not deteriorated. Two or more kinds of them may be arranged regularly, or may exist at random in the polyimide.

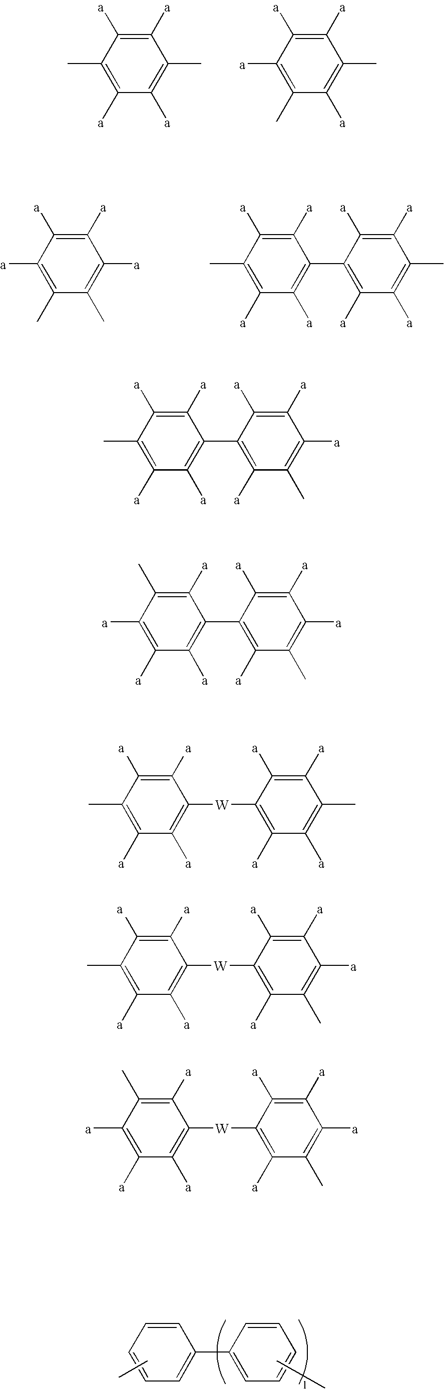

In the above formulae, “a” is independently a hydrogen atom or monovalent organic group, and a plurality of “a” may be bonded to each other. W is a divalent organic group or a bond. “l” is a natural number equal to 2 or more.

Furthermore, in the above formulae, “W” is a divalent organic group or a bond such as bonds as follows.

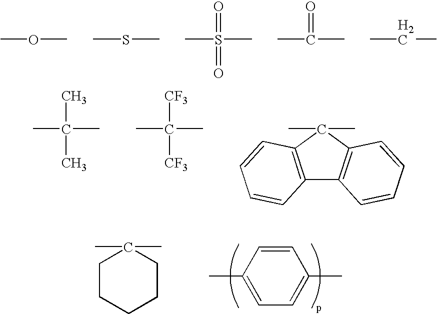

In the above formulae, “p” is a natural number equal to 1 or more.

Furthermore, as “a” in the above formulae, the monovalent organic group to be introduced to the aromatic ring may be, as well as a hydrogen atom, halogen atom, hydroxy group, mercapto group, primary amino group, secondary amino group, tertiary amino group, cyano group, silyl group, silanol group, alkoxy group, nitro group, carboxy group, acetyl group, acetoxy group, sulfo group, saturated or unsaturated alkylether group, arylether group, unsaturated alkylthioether group, arylthioether group, saturated or unsaturated alkyl group, saturated or unsaturated halogenated alkyl group, or aromatic group such as phenyl or naphthyl, allyl group and so on.

These structures are preferably used at a mol ratio 50% or more relative to all structures derived from diamine.

From the viewpoint of the low expansion property, as for R⁷ which is a structure derived from the diamine component included in the formula (1), it is preferable that two or more kinds of R⁷ is included in the polyimide molecule. Particularly, it is preferable that two or more kinds of structure selected from the above-listed preferable structures are included.

On the other hand, if a diamine having a siloxane skeleton such as 1,3-bis(3-aminopropyl)tetramethyldisiloxane is used as the diamine, the modulus of elasticity is lowered, so that the glass transition temperature can be lowered.

Here, it is preferable to select the aromatic diamine from the viewpoint of heat resistance. However, depending on the desired property, diamines other than the aromatic diamine, such as aliphatic diamine or siloxane diamine, may be used, within a range no more than 60 mol %, preferably no more than 40 mol % relative to the whole diamine component.

The polyimide of the present invention may have a repeating unit other than the formula (1), in order to achieve the object of the invention for improving the properties such as the heat resistance and the dimensional stability. For example, the polyimide of the present invention may have a repeating unit containing an imide structure other than the formula (1), or may have a repeating unit containing a structure other than the imide structure, such as a repeating unit of amide structure (repeating unit of polyamide).

The repeating unit containing the imide structure other than the formula (1) can be represented by the following formula (2). The polyimide having the repeating unit represented by the formula (1) and the repeating unit represented by the formula (2) can be represented by the following formula (3). The polyimide represented by the formula (3) may have a repeating unit other than the formula (1) and the formula (2).

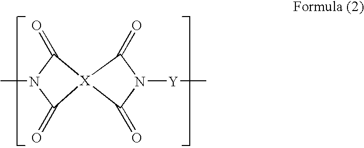

In the above formula (2), X is a tetravalent organic group, and Y is a divalent organic group. The groups represented by the same symbols among the repeating units existing in the same molecule may be different atoms or structures.
Formula (3)

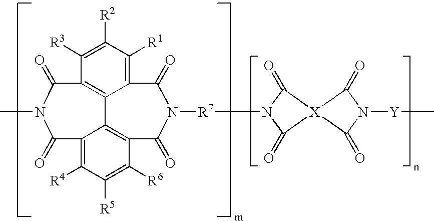

In the above formula (3), R¹ to R⁶, R⁷, X and Y are the same as in the case of the formula (1) or (2). The groups represented by the same symbols among the repeating units existing in the same molecule may be different atoms or structures. “m” is a natural number equal to 1 or more, and n is a natural number equal to 0 or more. The unit of the formula (1) and the unit of the formula (2) may be arranged at random, or may be arranged regularly.

The imide structure other than the formula (1) is introduced into the polyimide chain by using an acid dianhydride other than 2,2′,6,6′-biphenyltetracarboxylic dianhydride or the derivatives thereof.

As a method for producing the polyimide of the present invention, conventional methods can be applied. For example, it is possible to use, without limitation:

(1) a method in which polyamide acid as a precursor is synthesized from acid dianhydride and diamine, and this polyamide acid is formed and then heated to imidize the formed product;

(2) a method in which a polyimide solution is obtained by heating an amide acid in the solution, or using a dehydration catalyst such as acetic anhydride or dicyclohexylcarbodiimide, and then this polyimide solution is coated to form the product; and

(3) a method in which diimide monomer is firstly synthesized by using acid dianhydride and two equivalent of monoamine having a reaction site, and then a plurality of diimide monomers are bonded to each other to form polyimide.

As described above, the acid dianhydride used herein may be not only 2,2′,6,6′-biphenyltetracarboxylic dianhydride but also a derivative preliminarily having a substituent introduced at one or more of R¹ to R⁶ according to the purpose. As the acid dianhydride, other acid dianhydrides may be used with 2,2′,6,6′-biphenyltetracarboxylic dianhydride and/or the derivative thereof Two or more kinds of 2,2′,6,6′-biphenyltetracarboxylic dianhydride and/or the derivative thereof, and other acid dianhydrides may be used together, insofar as the transparency of the polyimide is maintained.

From the viewpoint of the heat resistance, a rigid acid dianhydride, especially an aromatic acid dianhydride is preferable as the acid dianhydride which can be used together with 2,2′,6,6′-biphenyltetracarboxylic dianhydride and/or the derivative thereof, i.e. as the acid dianhydride constituting a part of symbol X of the formula (2). According to desired physical properties, acid dianhydride other than 2,2′,6,6′-biphenyltetracarboxylic dianhydride may be used within 70 mol %, preferably within 50 mol %, relative to the whole amount of acid dianhydride.

As other acid dianhydride which can be used together with 2,2′,6,6′-biphenyltetracarboxylic dianhydride and/or the derivatives thereof, there may be, for example, ethylenetetracarboxylic dianhydride, butanetetracarboxylic dianhydride, cyclobutanetetracarboxylic dianhydride, cyclopentanetetracarboxylic dianhydride, pyromellitic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,2-bis{4-[4-(1,2-dicarboxy)phenoxy]phenyl}-1,1,1,3,3,3-hexafuloropropane dianhydride, 2,2-bis{4-[3-(1,2-dicarboxy)phenoxy]phenyl}-1,1,1,3,3,3-propane dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride or the like. They may be used solely or in a mixture of two or more kinds. As tetracarboxylic dianhydride which may be used particular preferably, there may be pyromellitic dianhydride, 3,3′,4,4′-benzophenonetetracarboxylic dianhydride, 3,3′,4,4′-biphenyltetracarboxylic dianhydride, bis(3,4-dicarboxyphenyl)ether dianhydride, or 2,2-bis(3,4-dicarboxyphenyl)-1,1,1,3,3,3-hexafluoropropane dianhydride.

In order to obtain the low expansion property, it is preferable that X in the formula (2) includes at least one of the following structures.

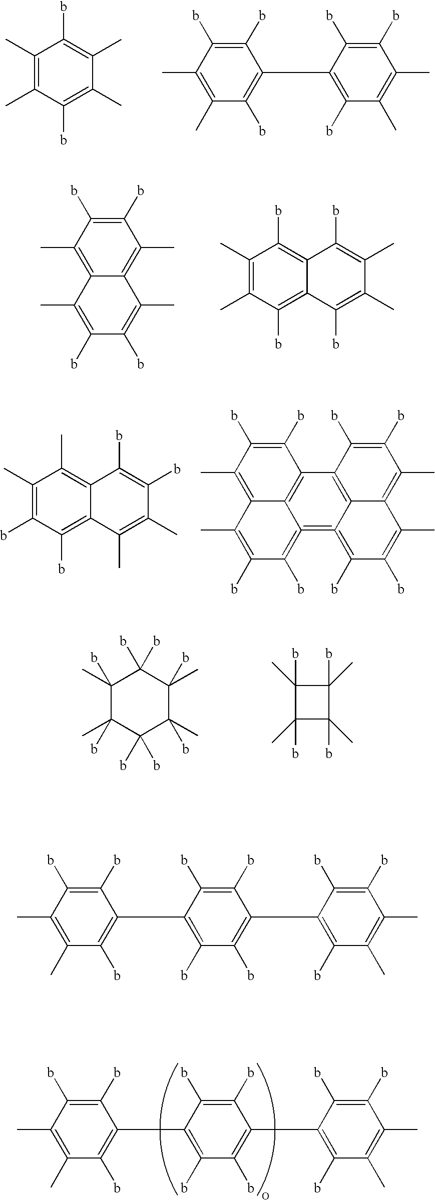

In the above formula, b is independently a hydrogen atom or monovalent organic group, and a plurality of b may be bonded to each other. “O” is a natural number equal to 2 or more.

More specifically, from the viewpoint of availability and the heat resistance, pyromellitic dianhydride, 2,5-fluoropyromellitic dianhydride, 2,5-trifluoromethylpyromellitic dianhydride, 3,3′,4,4′-biphenyltetracarboxylic dianhydride and 1,4,5,8-naphthalenetetracarboxylic dianhydride are particularly preferable.

Next, a method of synthesizing 2,2′,6,6′-biphenyltetracarboxylic dianhydride which is a raw material of the polyimide according to the present invention and a method of synthesizing the polyimide will be hereinafter described in detail, however, the present invention is not limited thereto. 2,2′,6,6′-biphenyltetracarboxylic dianhydride, which has the most basic structure among acid component materials, can be obtained by an oxidation of pyrene. That is, firstly, pyrene is dissolved in dichloromethane. After dissolving the pyrene completely, acetonitrile and water are added and agitated. Sodium periodate as an oxidizer and ruthenium trichloride as a catalyst are added thereto followed by agitation for 10 to 30 hours at a room temperature. After reaction, a precipitate is filtered. The precipitate is extracted with acetone followed by filtering. The extracted acetone is concentrated followed by drying, and refluxed by dichloromethane for 4 to 10 hours followed by filtering. The obtained white solid is 2,2′,6,6′-biphenyltetracarboxylic acid, which is a precursor of 2,2′,6,6′-biphenyltetracarboxylic dianhydride. After the obtained 2,2′,6,6′-biphenyltetracarboxylic acid is refluxed with acetic anhydride for 3 hours, a solvent is distilled away. The obtained solid matter is refined by sublimation under the condition of 0.8 mmHg (106.4 Pa) pressure and 230° C., thus obtained a desired 2,2′,6,6′-biphenyltetracarboxylic dianhydride.

Next, an example of a method for synthesizing the polyimide from the above-mentioned 2,2′,6,6′-biphenyltetracarboxylic dianhydride as an acid component and 4,4′-diamino diphenyl ether as an amine component will be explained. Firstly, equimolar 2,2′,6,6′-biphenyltetracarboxylic dianhydride is gradually added to dimethyl acetamide in which 4,4′-diaminodiphenylether is dissolved, and then agitated at a room temperature. After agitation for 1 to 20 hours, the reaction liquid is dropped into the agitated diethylether to reprecipitate the polyamide acid. The obtained polyamide acid is dissolved in dimethyl acetamide again, and then coated onto a substrate such as glass, and then dried to form a coating film of polyamide acid. The film is heated to obtain the polyimide coating film.

In the case that a chemical imidization is performed instead of thermal dehydration, a known compound may be used as a dehydration catalyst, for example, amine such as pyridine or β-picoline acid, carbodiimide such as dicyclohexylcarbodiimide, acid anhydride such as acetic anhydride, and so on. Besides the acetic anhydride, the acid anhydride may be propionic anhydride, n-butylic anhydride, benzoic anhydride, trifluoroacetic anhydride and so on, but not limited to them. In this case, tertiary amine such as pyridine or β-picoline acid may be used together therewith.

As for the polyimide of the present invention as synthesized above, in order to achieve the excellent heat resistance and dimensional stability of the polyimide itself, it is preferable that a copolymerization ratio of an aromatic acid component and/or an aromatic amine component is as large as possible. Specifically, it is preferable that a ratio of the aromatic acid component relative to an acid component constituting the repeating unit of the imide structure is 50 mol % or more, particularly 70 mol % or more. It is preferable that a ratio of the aromatic amine component relative to the amine component constituting the repeating unit of the imide structure is 40 mol % or more, particularly 60 mol % or more. A wholly aromatic polyimide is particularly preferable.

Thus synthesized polyimide according to the present invention is characterized in that it has a dimensional stability. The linear thermal expansion coefficient is preferably 40 ppm or less, more preferably 20 ppm or less, when it is measured by a tensile load method with a thermal mechanical analyzer (e.g. Thermo Plus TMA 8310, Rigaku Corporation) under conditions that the load is 5.0×10⁻⁴ g/μm per cross section of the polyimide film and the heating rate is 10° C./min.

The weight average molecular weight of the polyimide of the present invention is preferably, depending on its use, in the range of 3 000 to 1 000 000, more preferably 5 000 to 500 000, and still more preferably 10 000 to 500 000.

If the weight average molecular weight is less than 3 000, the sufficient strength cannot be obtained when a coating layer or a film is made. If the weight average molecular weight is less than 10 000, number of ends of polymers, which cause coloring, relatively increases, thereby coloring may be caused in polyimide to be obtained. On the other hand, if the weight average molecular weight is more than 1 000 000, a viscosity increases and solubility declines, hence, it is hard to obtain a coating layer or a film having a smooth surface and a uniform thickness.

The molecular weight used herein means a polystyrene calibrated value by gel permeation chromatography (GPC). The value may be of a molecular weight of the polyimide precursor itself or may be of a value after a chemical imidization treatment by acetic anhydride or the like.

The polyimide of the present invention is characterized in that it has excellent dimensional stability. Furthermore, the heat resistance and the insulating property, which are the inherent characteristics of the polyimide, is not deteriorated and maintained suitably.

For example, the 5% weight reduction temperature measured in nitrogen atmosphere is preferably 250° C. or more, more preferably 300° C. or more. Particularly, in the case of the application in the field of electronics involving a solder reflow process, if the 5% weight reduction temperature is less than 250° C., there may be a risk that bubbles are caused by decomposition gas generated in the solder reflow process.

Here, the 5% weight reduction temperature means a temperature of a time point when a sample weight is reduced by 5% from the initial weight (i.e. a time point when the sample weight becomes 95% of the initial weight) during the measurement of the weight reduction with a thermogravimetric analyzer. Similarly, the 10% weight reduction temperature means a temperature of a time point when the sample weight is reduced by 10% from the initial weight.

From the viewpoint of the heat resistance, the glass transition temperature is preferably as high as possible. It is preferably 200° C. or more, more preferably 250° C. or more, when the glass transition temperature is determined by tan δ peak, which is typically identified as Tg and measured with a dynamic viscoelastic spectrometer under conditions that the vibration frequency is 1 Hz, and the heating rate is 5° C./min.

In the case that the polyimide of the present invention is obtained via the thermal imidization from the polyimide precursor, a crosslinking reaction may proceed partly among individual molecular chains, and form a crosslinked structure. Once the crosslinked structure is obtained, the rupture strength or the tearing elasticity improves. This case is preferable, since the strength of the polyimide film itself improves. Whether the crosslinked structure is formed or not can be judged by whether or not a rubber-like region is detected in the dynamic viscoelastic measurement.

As described above, the polyimide according to the present invention shows the high heat resistance and the dimensional stability. The present invention can solve the problem that the selection range of diamine is restricted in order to achieve the low expansion property, or the problem that the solubility of the precursor is lowered. Therefore, it is possible to obtain the polyimide coating layer, film or product having the heat resistance equal to that of the conventional aromatic polyimide.

The polyimide according to the present invention may be used for a coating or molding process in order to produce a product or member directly therefrom, or may be used for preparing a polyimide resin composition in which the polyimide according to the present invention is dissolved or dispersed in a solvent if needed, and a photocuring or thermosetting component, a non-polymerizable binder resin other than the polyimide according to the present invention, and other components are compounded therewith.

As the solvent into which the polyimide resin composition is dissolved, dispersed or diluted, various general-purpose solvents can be used.

The general-purpose solvent which can be used may be, for example, ethers such as diethyl ether, tetrahydrofuran, dioxane, ethylene glycol dimethyl ether, ethylene glycol diethyl ether, propylene glycol dimethyl ether, propylene glycol diethyl ether or the like; glycol monoethers (that is, so called cellosolves) such as ethylene glycol monomethyl ether, ethylene glycol monoethyl ether, propylene glycol monomethyl ether, propylene glycol monoethyl ether, diethylene glycol monomethyl ether, diethylene glycol monoethyl ether or the like; ketones such as methyl ethyl ketone, acetone, methyl isobutyl ketone, cyclopentanone, cyclohexanone or the like; esters such as ethyl acetate, butyl acetate, n-propyl acetate, i-propyl acetate, n-butyl acetate, i-butyl acetate, acetic ester of the above-mentioned glycol monoethers (for example, methyl cellosolve acetate, ethyl cellosolve acetate), methoxypropyl acetate, ethoxypropyl acetate, dimethyl oxalate, methyl lactate, ethyl lactate or the like; alcohols such as ethanol, propanol, butanol, hexanol, cyclohexanol, ethylene glycol, diethylene glycol, glycerin or the like; halogenated hydrocarbons such as methylene chloride, 1,1-dichloroethane, 1,2-dichloroethylene, 1-chloropropane, 1-chlorobutane, 1-chloropentane, chlorobenzene, bromobenzene, o-dichlorobenzene, m-dichlorobenzene or the like; amides such as N,N-dimethylformamide, N,N-dimethylacetamide or the like; pyrrolidones such as N-methyl pyrrolidone or the like; lactones such as _{Y}-butyrolactone or the like; sulfoxides such as dimethyl sulfoxide or the like, other organic polar solvents or the like. Moreover, there may be aromatic hydrocarbons such as benzene, toluene, xylene or the like and other organic nonpolar solvents or the like. These solvents can be used alone or in combination.

As a photocuring component, a compound having one or more ethylenically unsaturated bonds may be used. For example, there may be amide-based monomer, (meth)acrylate monomer, urethane (meth)acrylate oligomer, polyester (meth)acrylate oligomer, epoxy (meth)acrylate, and (meth)acrylate containing hydroxyl group, aromatic vinyl compounds such as styrene or the like. Herein, “(meth)acrylate” means either acrylate or methacrylate.

In the case of using the photocuring compound having such an ethylenically unsaturated bond, a photoradical generator may be further added thereto.

Any known polymer compound or radical reactive compound or other curing-reactive compound can be used as a photocuring or thermosetting component other than the photocuring compound having the ethylenically unsaturated bond, or as other non-polymerizable binder resin. Examples of the known polymer compound or curing-reactive compound include an organic polyisocyanate such as tolylene diisocyanate, 4,4′-diphenylmethane diisocyanate, 4,4′-dicyclohexylmethan diisocyanate, hexamethylene diisocyanate and isophorone diisocyanate; a polymer and copolymer of acryl or vinyl compound such as vinyl acetate, vinyl chloride, acrylic acid ester and methacrylic acid ester; a styrene resin such as polystyrene; an acetal resin such as formal resin and butyral resin; a silicone resin; a phenoxy resin; an epoxy resin typified by bisphenol A type epoxy resin or the like; an urethane resin such as polyurethane; a phenol resin; a ketone resin; a xylene resin; a polyamide resin and the precursor thereof; a polyimide resin and the precursor thereof; a polyether resin; a polyphenylene ether resin; a polybenzoxazole resin; a cyclic polyolefin resin; a polycarbonate resin; a polyester resin; a polyallylate resin; a polystyrene resin; a novolac resin; an alicyclic polymer such as polycarbodiimide, polybenzoimidazole and polynorbornene; siloxane-type polymer and so on. Nevertheless, the usable compound is not limited to the above-listed compounds. These compounds may be used solely, or may be used in combination of two or more kinds.

In the case of using the non-polymerizable polymer binder resin, the weight average molecular weight is usually preferably 3000 or more, depending on the application of the resin composition. On the other hand, if the molecular weight is too high, the solubility or processability is lowered. Therefore, the weight average molecular weight is usually preferably 10 000 000 or less.

In order to impart the processability or various functionalities to the resin composition according to the present invention, various organic or inorganic low molecular or high molecular (polymer) compounds may be also compounded besides the above. For example, dyes, surfactants, leveling agents, plasticizers, microparticles, sensitization agents and so on may be used. The microparticles may include organic microparticles such as polystyrene or polytetrafluoroethylene; inorganic microparticles such as colloidal silica, carbon or phyllosilicate; and the like, which may be porous or have a hollow structure. Examples of the function or form of these microparticles include pigments, fillers, fibers and the like.

The polyimide resin composition according to the present invention usually contains the polyimide represented by the formula (1) in the range of 5 to 99.9 wt % relative to the total solid content of the resin composition. Also, the compounding ratio of other optional components is preferably in the range of 0.1 wt % to 95 wt % relative to the total solid content of the polyimide resin composition. If it is less than 0.1 wt %, the effect of the addition of additives is poorly exerted. If it is more than 95 wt %, the characteristics of the resin composition is poorly reflected upon a final product. It is to be noted that the solid content of the polyimide resin composition means the whole components other than solvents, and a liquid monomer component is included in the solid content.

The polyimide resin composition according to the present invention may be used in all known fields and products where the resin material is used, such as pattern-forming materials (resists), coating materials, paints, printing inks, adhesives, fillers, electronic materials, molding materials, resist materials, building materials, three-dimensional modeling, flexible display films, optical members or the like.

Particularly, the polyimide resin composition according to the present invention has a high dimensional stability in addition to the heat resistance and the insulating property inherent to the polyimide. Thereby, the polyimide of the present invention is suitable for fields and produces requiring these properties, such as paint, printing ink, color filter, flexible display film, semiconductor device, electronic device, interlayer insulation film, wiring coating film, optical circuit, optical circuit component, antireflection film, hologram, and other optical member or building material.

As described above, the polyimide according to the present invention employs the polyimide structure having the 7-membered ring structured imide bond. Thereby, it is possible to obtain the low expansion polyimide coating layer, film or product.

The 2,2′,6,6′-biphenyltetracarboxylic dianhydride, which is a raw material of the 7-membered ring imide skeleton included in the polyimide according to the present invention, can be easily synthesized and is available at a low price. Therefore, the polyimide of the present invention can be supplied stably and at the low price.

Since the resin composition having the polyimide according to the present invention has the heat resistance, the dimensional stability and the insulating property, the resin composition is suitable for film or coating layer of any known components requiring the heat resistance and the low expansion (dimensional stability). For example, it is expected in a use as insulating material or structure for semiconductor or electronics components such as hard disc drive suspension, or flexible or rigid print wiring board.

The present invention may not be limited to the above embodiments. The above embodiments are merely examples, and any one having substantially the same constitution and effect as the technical idea disclosed in the scope of the claims of the present invention is included in the technical scope of the present invention.

### EXAMPLES

(Synthesis of Carboxylic Dianhydride)

A 2 L eggplant-shape flask was charged with 15 g (74 mmol) of pyrene and the pyrene was dissolved by dichloromethane of 320 ml. After the pyrene was completely dissolved, 320 ml of acetonitrile and 480 ml of distilled water were added and agitated. Thereto, 150 g of sodium periodate as an oxidant and 650 mg of ruthenium (III) chloride as a catalyst were added and agitated at a room temperature for 22 hours. After reaction, a precipitate was filtrated, and the precipitate was extracted using acetone and filtrated. After the extracted acetone was condensed and dried, reflux was performed using dichloromethane for 4 hours followed by filtrating to obtain powders. Until the powders were completely changed to a white color, the extraction using acetone and reflux using dichloromethane were repeated, thereby 10.2 g of 2,2′,6,6′-biphenyltetracarboxylic acid was obtained.

The obtained 2,2′,6,6′-biphenyltetracarboxylic acid was refluxed using acetic anhydride for 3 hours, and then the solvent was removed. The obtained solid substance was refined by sublimation under the condition that the pressure was 0.8 mmHg (106.4 Pa) and the temperature was 230° C., thereby desired white powders of 2,2′,6,6′-biphenyltetracarboxylic dianhydride (2,2′,6,6′-BPDA) was obtained.

(Synthesis of Precursor Solution)

(1) Synthesis of Precursor Solution 1

A 50 ml three-neck flask was charged with 1.20 g (6 mmol) of 4,4′-diaminodiphenyl ether and the 4,4′-diaminodiphenyl ether was dissolved in 5 ml of N-methyl-2-pyrrolidone (NMP) dehydrated, then agitated under nitrogen flow while cooling the flask in an ice bath. Thereto, 1.77 g (6 mmol) of 2,2′,6,6′-BPDA was added little by little in such a manner that 10 equally divided portions thereof are added every 30 minutes. After addition, the solution was agitated in an ice bath for 5 hours, so that thick liquid (precursor solution 1) was obtained.

The precursor solvent was diluted to a concentration of 0.5 wt % by NMP, and then subjected to a GPC (HLC-8120 available from Tosoh Corporation: using a coupled polystyrene gel columns TSK gel α-M as column, and NMP as a carrier solvent in which both 0.03 mol/L lithium bromide and 0.03 mol/L phosphoric acid are dissolved). The measurement was performed under conditions that the measurement temperature was 40° C. and the flow rate was 0.5 ml/min. The determined weight average molecular weight was 42000.

(2) Synthesis of Precursor Solution 2

A 50 ml three-neck flask was charged with 1.20 g (6 mmol) of 4,4′-diaminodiphenyl ether and the 4,4′-diaminodiphenyl ether was dissolved in 5 ml of N-methyl-2-pyrrolidone (NMP) dehydrated, then agitated under nitrogen flow while cooling the flask in an ice bath. Thereto, a mixture of 0.87 g (3 mmol) of 2,2′,6,6′-BPDA and 0.65 g (3 mmol) of pyromellitic dianhydride (PMDA) was added little by little in such a manner that 10 equally divided portions of the mixture are added every 30 minutes. After addition, the solution was agitated in an ice bath for 5 hours, so that thick liquid (precursor solution 2) was obtained.

The weight average molecular weight determined by a similar manner to the measurement of the precursor solution 1 was 73000.

(3) Synthesis of Precursor Solution 3

A 50 ml three-neck flask was charged with 0.6 g (3 mmol) of 4,4′-diaminodiphenyl ether and 0.32 g (3 mmol) of p-phenylenediamine. They were dissolved in 5 ml of N-methyl-2-pyrrolidone (NMP) dehydrated, then agitated under nitrogen flow while cooling the flask in an ice bath. Thereto, 1.77 g (6 mmol) of 2,2′,6,6′-BPDA was added little by little in such a manner that 10 equally divided portions thereof are added every 30 minutes. After addition, the solution was agitated in an ice bath for 5 hours, so that thick liquid (precursor solution 3) was obtained.

The weight average molecular weight determined by a similar manner to the measurement of the precursor solution 1 was 32000.

(Examples)

Each of the synthesized precursor solutions 1-3 was spin-coated directly onto a glass, and then dried for 30 minutes on a hot plate heated to 80° C. Then, they are heated in an oven at 350° C. under a nitrogen atmosphere for 1 hour, so that polyimide films 1-3 were obtained, respectively.

The polyimide films each formed on a glass were dipped in distilled water for 24 hours, so that the polyimide films were peeled off from glass, respectively. Each of the peeled film was insoluble in NMP, and the thickness of each film was 20 μm±2 μm.

(Dynamic Viscoelasticity Evaluation)

Dynamic viscoelasticity of each polyimide film made in the above-mentioned thermal property evaluation was measured with a viscoelastic analyzer (Solid Analyzer RSA II available from Rheometric Scientific Inc) under conditions that the frequency was 1 Hz, and the heating rate was 5° C./min.

Polyimide 1 showed the glass transition temperature 350° C. However, polyimide 2 and polyimide 3 did not show their glass transition temperatures in a measurement range up to 400° C.

TABLE 1

| | Tg/° C. |
|---|---|
| Polyimide film 1 | 350 |
| Polyimide film 2 | >400 |
| Polyimide film 3 | >400 |

(Linear Thermal Expansion Coefficient Evaluation)

Linear thermal expansion coefficient of each film made in the above-mentioned thermal property evaluation was measured with a thermal mechanical analyzer (Thermo Plus TMA 8310 available from Rigaku Corporation) under conditions that the heating rate was 10° C./min and the tensile load was 5 g.

As a result, with regard to the linear thermal expansion coefficient in a range from 50 to 100° C., polyimide 1 showed 25 ppm, polyimide 2 showed 23 ppm and polyimide 3 showed 16 ppm.

TABLE 2

| | Linear thermal expansion |
|---|---|
| | coefficient/ppm |
| Polyimide film 1 | 25 |
| Polyimide film 2 | 23 |
| Polyimide film 3 | 16 |

From these results, the polyimide having the 7-membered ring imide structure of the present invention has a good heat resistance, and can form a low expansion film. Thereby, the polyimide according to the present invention is suitable for fields and products requiring these properties, such as paint, printing ink, color filter, flexible display film, semiconductor device, electronic device, interlayer insulation film, wiring coating film, optical circuit, optical circuit component, antireflection film, hologram and other optical member or building material.

1. A polyimide comprising a repeating unit represented by a following formula (1): 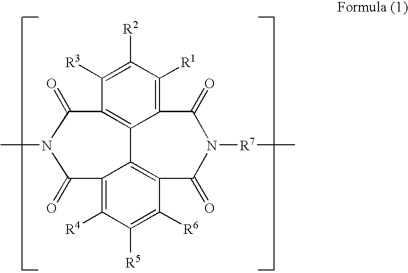
wherein R¹ to R⁶ is independently a hydrogen atom or monovalent organic group, and R¹ to R⁶ may be bonded to each other; R⁷ is a divalent organic group; and groups represented by the same symbol among the repeating units existing in the same molecule may be different atoms or structures.

2. The polyimide according to claim 1, wherein the repeating unit represented by the formula (1) has two or more kinds of the repeating unit among which structures of said R⁷ are different from each other.

3. The polyimide according to claim 1, wherein said R⁷ in the repeating unit represented by the formula (1) is selected from the following structures: 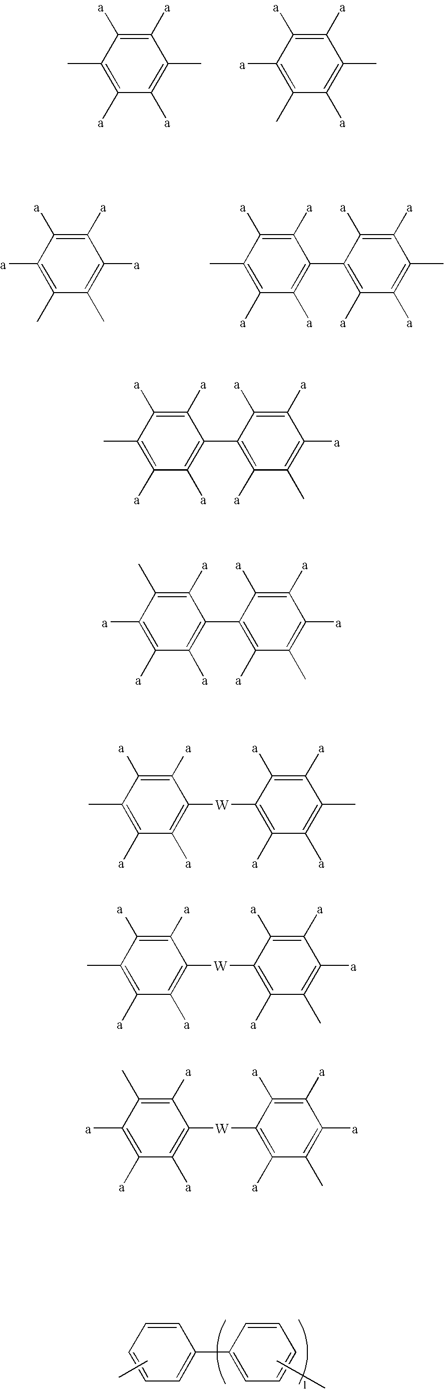
wherein “a” is independently a hydrogen atom or monovalent organic group, and a plurality of “a” may be bonded to each other. W is a divalent organic group. “I” is a natural number equal to 2 or more.

4. The polyimide according to claim 1 further comprising a repeating unit represented by a following formula (2): 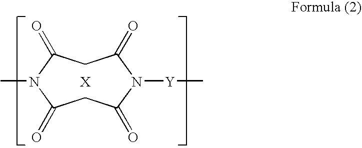
wherein X is a tetravalent organic group, and Y is a divalent organic group. Groups represented by the same symbols among the repeating units existing in the same molecule may be different atoms or structures.

5. The polyimide according to claim 4, wherein said X in the formula (2) includes at least one of the following structures: 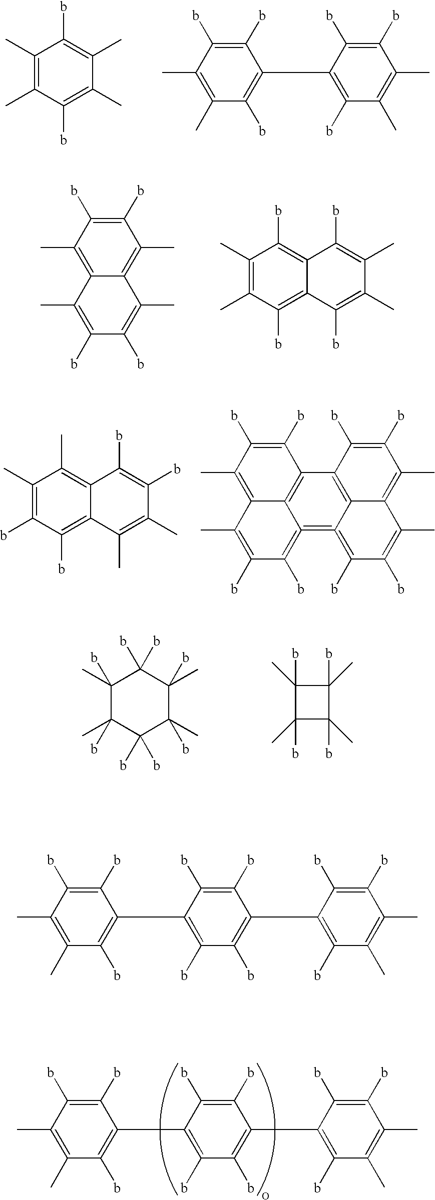
wherein b is independently a hydrogen atom or monovalent organic structure, and a plurality of b may be bonded to each other. O is a natural number equal to 2 or more.

6. The polyimide according to claim 1, wherein a linear thermal expansion coefficient is 40 ppm or less.

7. The polyimide according to claim 1, wherein a glass transition temperature is 200° C. or more.

8. The polyimide according to claim 1, wherein the formula (1) is a repeating unit of a wholly aromatic polyimide.

9. The polyimide according to claim 1, wherein a weight average molecular weight is 10,000 or more.

10. A polyimide resin composition comprising a polyimide comprising a repeating unit represented by a following formula (1):
Formula (1) 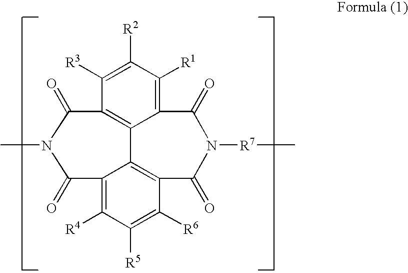
wherein R¹ to R⁶ is independently a hydrogen atom or monovalent organic group, and R¹ to R⁶ may be bonded to each other; R⁷ is a divalent organic group; and groups represented by the same symbol among the repeating units existing in the same molecule may be different atoms or structures.

11. The polyimide resin composition according to claim 10, wherein the composition is used as a pattern forming material.

12. The polyimide resin composition according to claim 10, wherein the composition is used as paint or printing ink; or a forming material of color filter, flexible display film, semiconductor device, electronic device, interlayer insulation film, wiring coating film, optical circuit, optical circuit component, antireflection film, hologram, optical member or building material.

13. An article selected from a group consisting of printed matter, color filter, flexible display film, semiconductor device, electronic device, interlayer insulation film, wiring coating film, optical circuit, optical circuit component, antireflection film, hologram, optical member and building material, at least a part of which is formed by the polyimide resin composition comprising a polyimide comprising a repeating unit represented by a following formula (1) or a cured material thereof: 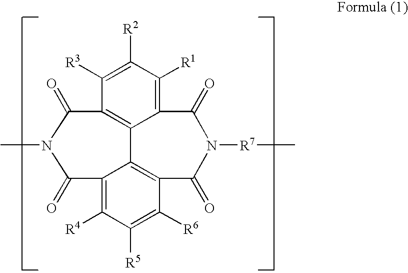
wherein R¹ to R⁶ is independently a hydrogen atom or monovalent organic group, and R¹ to R⁶ may be bonded to each other; R⁷ is a divalent organic group; and groups represented by the same symbol among the repeating units existing in the same molecule may be different atoms or structures.
